(19) United States
(12) Patent Application Publication
(10) Pub. No.: US 2014/0170057 A1
(43) Pub. Date: Jun. 19, 2014

(54) METHOD AND APPARATUS FOR MANUFACTURING GRAPHENE SHEET

(71) Applicant: INDUSTRIAL TECHNOLOGY RESEARCH INSTITUTE, Hsinchu (TW)

(72) Inventors: Kun-Ping Huang, Miaoli County (TW); Chih-Chen Chang, New Taipei City (TW); Chwung-Shan Kou, Hsinchu City (TW); Yu-Tse Hsieh, Taoyuan County (TW)

(73) Assignee: Industrial Technology Research Institute, Hsinchu (TW)

(21) Appl. No.: 13/855,652

(22) Filed: Apr. 2, 2013

(30) Foreign Application Priority Data
Dec. 13, 2012 (TW) 101147087

(51) Int. Cl. C01B 31/04

(52) U.S. Cl. CPC C01B 31/0446
USPC 423/448; 422/186.04

(57) ABSTRACT

Disclosed is an apparatus for manufacturing graphene sheets. The apparatus includes a gas tube, and a hydrocarbon gas source connected to a front part of the gas tube for providing a hydrocarbon gas through the gas tube. The apparatus also includes a microwave generator to generate a microwave passing a middle part of the gas tube through a waveguide tube to form a microwave plasma torch from the hydrocarbon gas, wherein the hydrocarbon gas is cracked by the microwave plasma torch to form graphene sheets. The apparatus includes a tube collector connected to a back part of the gas tube for collecting the graphene sheets.

### CROSS REFERENCE TO RELATED APPLICATIONS

The present application is based on, and claims priority from, Taiwan Application Serial Number 101147087, filed on Dec. 13, 2012, the disclosure of which is hereby incorporated by reference herein in its entirety

### TECHNICAL FIELD

The technical field relates to graphene sheets, and in particular relates to a method and an apparatus for manufacturing the same.

### BACKGROUND

Graphene sheets have excellent properties such as heat dissipation, electrical conductivity, and mechanical strength, and thereby being applied as heat dissipation glue, heat conduction glue, extremely reinforced composite material, and the likes. Conventional chemical methods may crack the graphene block by a large amount of chemicals at a high temperature to form few-layer graphene sheets of a low yield. Electrolysis may manufacture the few-layer graphene sheets, but it costs a long period. In addition, the electrolysis also damages the graphene sheets, such that the graphene cannot be rapidly manufactured in mass production.

Microwave plasma torch may manufacture the graphene sheets. See Nano Letters Vol. 8, 2012-2016 2008 “Substrate-Free Gas-Phase Synthesis of Graphene Sheets”. In this paper, liquid ethanol droplets pass to the microwave plasma torch to form graphene sheets. This method cannot be mass production due to uncontrollable flow rate of the liquid hydrocarbon composite source (ethanol) and unstable plasma flow.

Accordingly, a novel method and a related apparatus to manufacture graphene sheets in mass production are still called-for.

### SUMMARY

One embodiment of the disclosure provides an apparatus for manufacturing graphene sheets, comprising: a gas tube; a hydrocarbon gas source connected to a front part of the gas tube for providing a hydrocarbon gas through the gas tube; a microwave generator for generating a microwave passing a middle part of the gas tube through a waveguide tube to form a microwave plasma torch from the hydrocarbon gas, wherein the hydrocarbon gas is cracked by the microwave plasma torch to form graphene sheets; and a tube collector connected to a back part of the gas tube for collecting the graphene sheets.

One embodiment of the disclosure provides a method for manufacturing graphene sheets, comprising: providing a hydrocarbon gas through a gas tube; providing a microwave through a waveguide tube to pass a middle part of the gas tube and form a microwave plasma torch from the hydrocarbon gas, wherein the hydrocarbon gas is cracked by the microwave plasma torch to form graphene sheets; and collecting the graphene sheets by a tube collector connected to a back part of the gas tube.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows an apparatus for manufacturing graphene sheets in one embodiment of the disclosure;

FIG. 2 shows an apparatus for manufacturing graphene sheets in another embodiment of the disclosure; and

FIG. 3 shows an apparatus for manufacturing graphene sheets in other embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

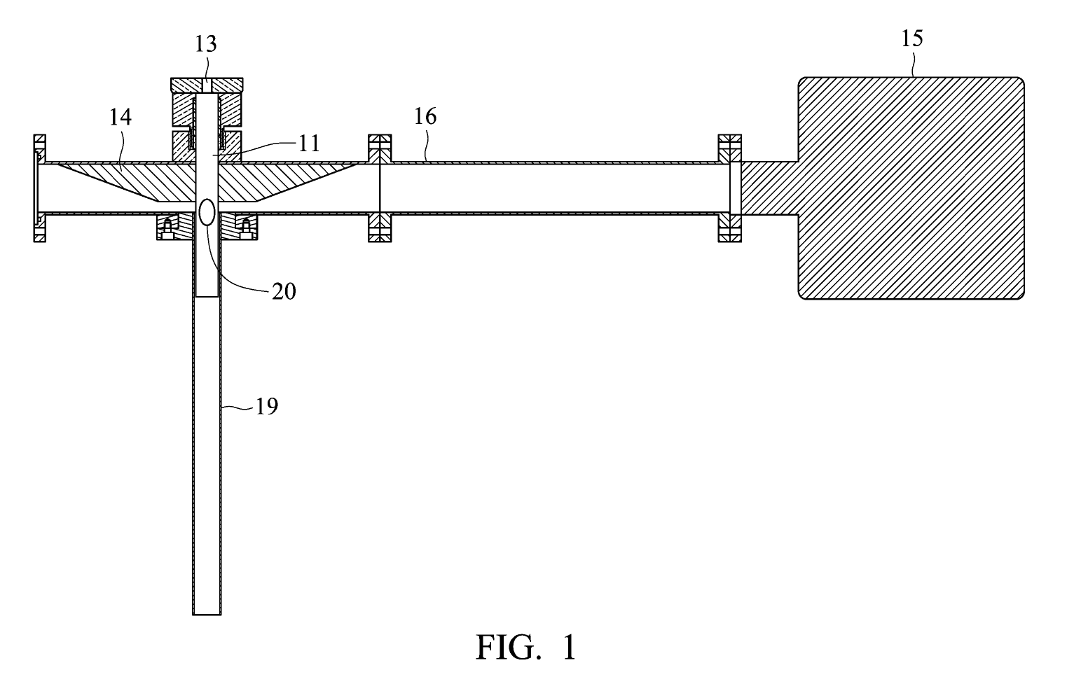

FIG. 1 shows an apparatus for manufacturing graphene sheets in one embodiment of the disclosure. A major part of the apparatus is a gas tube 11. A front part of the gas tube 11 is connected to a hydrocarbon gas source 13, a middle part of the gas tube 11 is connected to a microwave generator 15 through a waveguide tube 16, and a back part of the gas tube 11 is connected to a tube collector 19. In one embodiment, the gas tube 11 is a thermal resistant material without absorbing microwave, such as silicon oxide (quartz), aluminum oxide, magnesium oxide, zirconium oxide, or the likes. The hydrocarbon gas source 13 may provide hydrocarbon gas such as methane, ethane, propane, butane, ethene, ethyne, other hydrocarbon gases, or combinations thereof to pass through the gas tube 11. For example, the hydrocarbon gas source can be a gas cylinder. In one embodiment, the hydrocarbon gas can be ethene, because its planar structure is benefit to form the graphene sheets of planar structure. The hydrocarbon gas has a flow rate of 0.1 m/s to 1 m/s. The hydrocarbon gas with an overly high flow rate may result in overly low yield (product/starting material) of the graphene sheets. On the other hand, the hydrocarbon gas with an overly low flow rate may result in overly low capacity (product/time) of the graphene sheets. Because the hydrocarbon gas is selected as a carbon source in the disclosure, the gas flow rate can be exactly controlled. Compared to liquid carbon sources (e.g. alcohol, high-carbon alkane such as pentane or hexane, or benzene), the hydrocarbon gas may omit a nebulization step and therefore simplify the apparatus complexity. The hydrocarbon gas source 13 may further mix other inert gas such as argon, helium, or combinations thereof with the hydrocarbon gas, thereby tuning a concentration of the hydrocarbon gas to help cracking the hydrocarbon gas. The inert gas is defined as a gas not reacted with the hydrocarbon gas. For keeping the purity and/or yield of the graphene sheets, no material which may react with the hydrocarbon gas (e.g. metal) is mixed with the hydrocarbon gas.

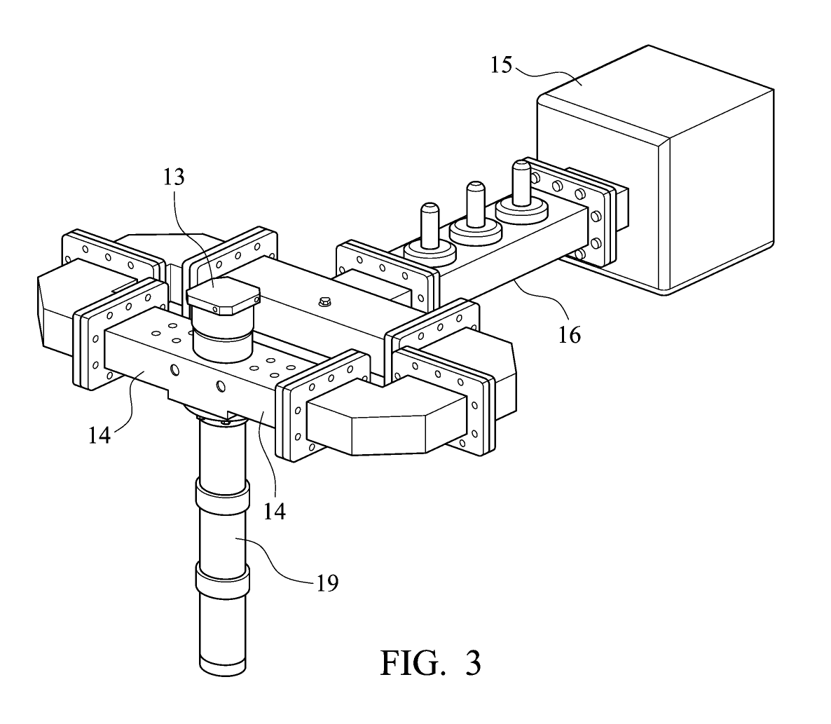

The microwave generated by the microwave generator 15 pass the middle part of the gas tube 11 through the waveguide tube 16, such that the hydrocarbon gas in the gas tube 11 forms a plasma. In one embodiment, the microwave generator 15 is set at a power of 100 W to 5 kW. The microwave generator 15 performed at an overly high power may easily form defect graphene in the graphene sheets. On the other hand, the microwave generator performed at an overly low power cannot synthesize the graphene sheets. As shown in FIG. 1, a low power microwave can be concentrated to a high power microwave by an optional microwave concentrator (e.g. waveguide block 14). Although the microwave generator 15 only connects to the right wave guide block 14 through the waveguide tube 16 in FIG. 1, those skilled in the art should understand that the microwave generator 15 may connect to the left wave guide block 14 through the waveguide tube 16, as shown in FIG. 3. A tungsten filament (not shown) extending into the gas tube 11 may ignite the microwave plasma to form a microwave plasma torch 20. As such, the hydrocarbon gas is cracked by the microwave plasma torch 20 to form the graphene sheets.

The graphene sheets are collected on inner wall of the tube collector 19 and 20. In one embodiment, the tube collector 19 can be nickel, copper, iron, or alloys thereof. In other embodiments, the body of the tube collector 19 can be other non-metal material such as quartz, aluminum oxide, magnesium oxide, or zirconium oxide. The tube collector 19 may have a top view shape of circle, square, rectangle, rhombus, or other suitable top view shapes if necessary. The tube collector 19 may help to catalyze the formation of the graphene sheets. In addition, free electrons of the plasma make the graphene sheets bring electricity. Therefore, static electricity of the tube collector 19 is benefit to collect the graphene sheets bringing static electricity. In other words, the tube collector 19 has catalytic effect and electrostatic precipitation effect.

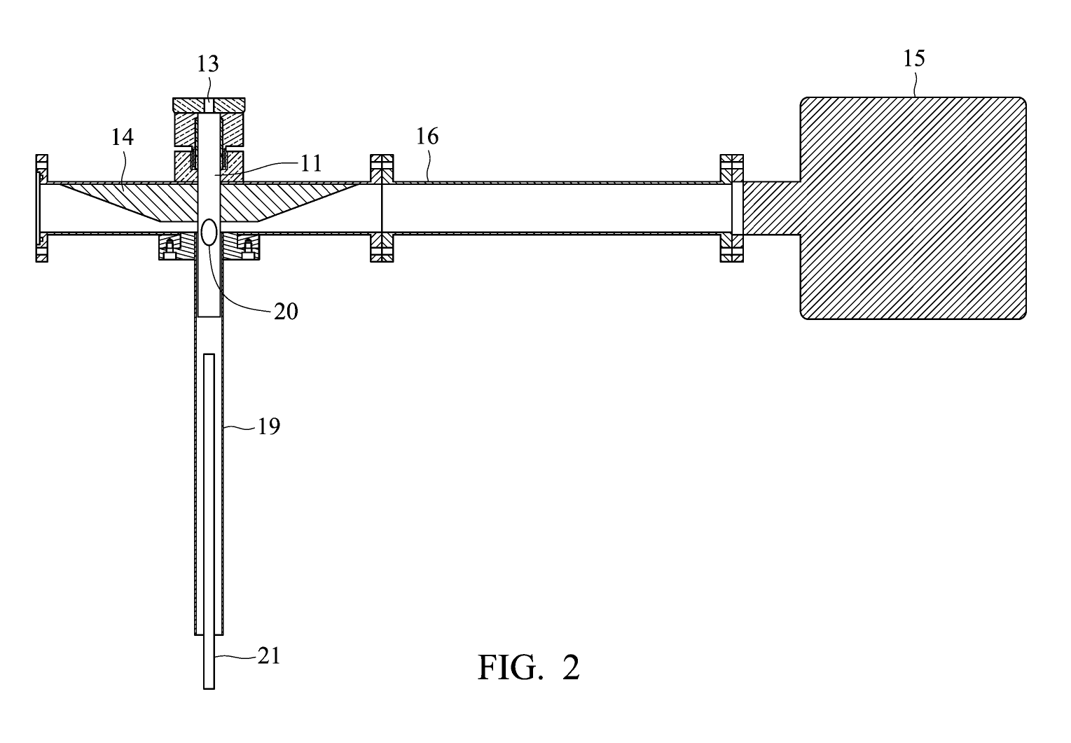

In another embodiment, a rod collector 21 is disposed in the tube collector 19, as shown in FIG. 2. The rod collector 21 can be nickel, copper, iron, alloys thereof, or other thermal resistant materials (e.g. quartz, glass, aluminum oxide, magnesium oxide, or zirconium oxide). The rod collector 21 can be massive, hollow with two closed end, hollow with one opened end and one closed end, or hollow with two opened end (tube-like) if necessary. It should be understood that only one rod collector 21 is shown in FIG. 2, but one skilled in the art may utilize two rod collectors 21, three rod collectors 21, or more rod collectors 21. The rod collector 21 may have a top view shape of circle, square, rectangle, rhombus, screw, or other suitable top view shapes if necessary. Three or more than three rod collectors 21 can be arranged in any manner which does not negatively influence the smooth flow of the hydrocarbon gas. Similar to the tube collector 19, the rod collector 21 may help to catalyze the formation of the graphene sheets. In other words, the graphene sheets are not only formed on the inner wall of the tube collector 19, but also formed on a surface of the rod collector 21. In the disclosure, no filtering device is fixed at a terminal of the tube collector 19, because the stability of the microwave plasma 20 will be negatively influenced by the filtering device due to hindering the flow of the hydrocarbon gas.

In the disclosure, the hydrocarbon gas serves as the carbon source, and the graphene sheets are collected by the tube collector. A large amount of single-layer graphene sheets (yield ≧30%) can be obtained by the apparatus with proper operation parameters.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

As shown in FIG. 1, a nickel steel (stainless steel) tube serving as a tube collector with a diameter of 2.4 cm and a length of 30 cm was connected to a quartz tube serving as a gas tube with a diameter of 2.4 cm and a length of 15 cm. Argon (10 slm) and methane (5 sccm) were then provided to pass through the quartz tube. A microwave generator of a microwave launcher (commercially available from Tokyo electric industry Co. Ltd.) was set to 500 W for forming a stable plasma torch. The microwave generator was run for 60 minutes and then switched off. 64 mg of graphene sheets (yield=30%) were then collected from inner wall of the nickel steel tube. In a Raman spectroscopy, the graphene sheets had an obvious characteristic peak 2D of 2650 cm⁻¹, and the graphene characteristic peak and a graphite characteristic peak G (˜1570 cm⁻¹) had an intensity ratio of about 0.6.

### Example 2

As shown in FIG. 1, a copper tube serving as a tube collector with a diameter of 2.4 cm and a length of 30 cm was connected to a quartz tube serving as a gas tube with a diameter of 2.4 cm and a length of 15 cm. Argon (10 slm) and methane (5 sccm) were then provided to pass through the quartz tube. A microwave generator of a microwave launcher (commercially available from Tokyo electric industry Co. Ltd.) was set to 500 W for forming a stable plasma torch. The microwave generator was run for 60 minutes and then switched off. 86 mg of graphene sheets (yield=40%) were then collected from inner wall of the copper tube. In a Raman spectroscopy, the graphene sheets had an obvious characteristic peak 2D of 2650 cm⁻¹, and the graphene characteristic peak and a graphite characteristic peak G (˜1570 cm⁻¹) had an intensity ratio of about 0.8.

### Example 3

As shown in FIG. 1, a constantan alloy tube serving as a tube collector with a diameter of 2.4 cm and a length of 30 cm was connected to a quartz tube serving as a gas tube with a diameter of 2.4 cm and a length of 15 cm. Argon (10 slm) and methane (5 sccm) were then provided to pass through the quartz tube. A microwave generator of a microwave launcher (commercially available from Tokyo electric industry Co. Ltd.) was set to 500 W for forming a stable plasma torch. The microwave generator was run for 60 minutes and then switched off. 107 mg of graphene sheets (yield=50%) were then collected from inner wall of the constantan alloy tube. In a Raman spectroscopy, the graphene sheets had an obvious characteristic peak 2D of 2650 cm⁻¹, and the graphene characteristic peak and a graphite characteristic peak G (˜1570 cm⁻¹) had an intensity ratio of about 1 or above.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. An apparatus for manufacturing graphene sheets, comprising:
a gas tube;
a hydrocarbon gas source connected to a front part of the gas tube for providing a hydrocarbon gas through the gas tube;
a microwave generator for generating a microwave passing a middle part of the gas tube through a waveguide tube to form a microwave plasma torch from the hydrocarbon gas, wherein the hydrocarbon gas is cracked by the microwave plasma torch to form graphene sheets; and
a tube collector connected to a back part of the gas tube for collecting the graphene sheets.

2. The apparatus as claimed in claim 1, wherein the gas tube comprises quartz, aluminum oxide, magnesium oxide, or zirconium oxide.

3. The apparatus as claimed in claim 1, wherein the hydrocarbon gas comprises methane, ethane, propane, butane, ethene, ethyne, or combinations thereof.

4. The apparatus as claimed in claim 1, wherein the tube collector comprises nickel, copper, iron, alloys thereof, quartz, glass, aluminum oxide, magnesium oxide, or zirconium oxide.

5. The apparatus as claimed in claim 1, further comprising at least one rod collector in the tube collector, and the rod collector comprises nickel, copper, iron, alloys thereof, quartz, glass, aluminum oxide, magnesium oxide, or zirconium oxide.

6. The apparatus as claimed in claim 1, wherein the hydrocarbon gas source mixes an inert gas with the hydrocarbon gas to tune a concentration of the hydrocarbon gas.

7. A method for manufacturing graphene sheets, comprising:
providing a hydrocarbon gas through a gas tube;
providing a microwave through a waveguide tube to pass a middle part of the gas tube and form a microwave plasma torch from the hydrocarbon gas, wherein the hydrocarbon gas is cracked by the microwave plasma torch to form graphene sheets; and
collecting the graphene sheets by a tube collector connected to a back part of the gas tube.

8. The method as claimed in claim 7, wherein the tube collector comprises nickel, copper, iron, alloys thereof, quartz, glass, aluminum oxide, magnesium oxide, or zirconium oxide.

9. The method as claimed in claim 8, wherein the hydrocarbon gas has a flow rate of 0.1 m/s to 1 m/s, and the hydrocarbon gas comprises methane, ethane, propane, butane, ethene, ethyne, or combinations thereof.

10. The method as claimed in claim 7, wherein the microwave generator is set at a power of 100 W to 5 kW.

11. The method as claimed in claim 7, further disposing a rod collector in the tube collector to collect the graphene sheets, and the rod collector comprises nickel, copper, iron, alloys thereof, quartz, glass, aluminum oxide, magnesium oxide, or zirconium oxide.

12. The method as claimed in claim 7, further mixing an inert gas with the hydrocarbon gas to tune a concentration of the hydrocarbon gas before the step of providing the hydrocarbon gas through the gas tube.
